(19) United States
(12) Patent Application Publication
(10) Pub. No.: US 2011/0025196 A1
(43) Pub. Date: Feb. 3, 2011

(54) HERMETIC PACKAGE WITH GETTER MATERIALS

(75) Inventors: Stefan Rakuff, Clifton Park, NY (US); Donald Seton Farquhar, Niskayuna, NY (US); Christian Maria Anton Heller, Albany, NY (US); Ahmet Gun Erlat, Clifton Park, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, Schenectady, NY (US)

(21) Appl. No.: 12/533,090

(22) Filed: Jul. 31, 2009

(51) Int. Cl. H01J 1/62

(52) U.S. Cl. 313/504

(57) ABSTRACT

Organic light emitting devices include a transparent substrate, a first transparent electrode disposed on the transparent substrate, a second electrode, an electroluminescent layer sandwiched between the electrodes, and a getter layer disposed on a light emitting surface of the substrate opposite the first transparent electrode, and comprising a metal selected from beryllium, magnesium, calcium, strontium, barium, radium and titanium.

### BACKGROUND

Electronic devices, such as organic photovoltaic devices, or organic light emitting diode (OLED) devices, are highly susceptible to water and/or oxygen. OLEDs have a number of beneficial characteristics, including their high efficiency, low activation voltage, fast response time, high brightness, high visibility due to self-emission, superior impact resistance, and ease of handling of the solid state devices in which they are used. OLEDs have practical application in television, graphic display systems, digital printing and lighting.

OLEDs are typically built as a laminate on top of a suitable substrate material such as glass, silicon, metal foils, or specialty plastics. The laminate layers consist of two electrodes, the anode and cathode; light emitting layers of luminescent organic solids as well as semiconducting layers for electron and hole transport. The light-emitting layer may also consist of a single layer containing all necessary luminescent organic material. When a voltage is applied across the two electrodes of the OLED device, electrons move from the cathode through the electron-injecting layer and finally into the layer(s) of luminescent organic material. At the same time, holes move from the anode through the optional hole-injecting layer and finally into the same organic light-emitting layer(s). When holes and electrons meet in the luminescent layer, they combine to cancel out each other's charge, and produce photons in the process. In a typical OLED, either the anode or the cathode is transparent to allow the emitted light to pass through. If it is desirable to allow light to be emitted from both sides of the OLED, both the anode and cathode can be transparent.

Alternatively, the organic light emitting layer may comprise two or more sublayers which carry out the functions of hole injection, hole transport, electron injection, electron transport and luminescence. Only the luminescent layer is required for a functioning device. However, the additional sublayers generally increase the efficiency with which holes and electrons recombine to produce light. Thus the organic light emitting layer can comprise one to four or more sublayers including, for example, a hole injection sublayer, a hole transport sublayer, a luminescent sublayer, and an electron injection sublayer. Also, one or more sublayers may comprises a material which achieves two or more functions such as hole injection, hole transport, electron injection, electron transport, and luminescence.

The color of light emitted by the organic molecules depends on the energy difference between the excited state and the ground state of the molecules or excitons. Typically, the applied voltage is about 3-10 V, and the external quantum efficiency (photons out/electrons in) is between 0.1% and 10%, but can be up to 20%, or more. The organic light emitting layer typically has a thickness of about 30-100 nm, and the electrodes each typically have a thickness of about 100-1000 nm. The wavelength of the light output depends on the particular electroluminescent material present in the device. The color of light can also be altered by the selection of special dopants, by mixing the light from layers off different transparent OLEDs, or by other techniques known in the art. For example, white light can be produced by mixing blue, red, and green light.

One of the factors limiting the widespread use of OLEDs has been the problem associated with their long-term stability. Part of the problem is that the OLED layers tend to be environmentally sensitive. In particular, it is well known that device performance degrades in the presence of water and/or oxygen. Exposing a conventional OLED to the atmosphere shortens its life significantly. The organic material in the light-emitting layer(s) and typical low work function cathode materials react with water vapor and/or oxygen. Operational lifetimes (depending on the initial brightness) of 5,000 to 35,000 hours have been obtained for evaporated films and greater than 5,000 hours for polymers. However, these values are typically reported for room temperature operation and protected from water vapor and oxygen. Lifetimes associated with operations outside these conditions are typically much shorter.

Hermetically sealed packages isolate the OLED device from environmental effects, and the present invention improves the protection provided for the OLED. The procedure to encapsulate an OLED consists of sealing it in a pouch shaped package. The package may consist of a bottom and a top layer with a continuous perimeter seal around the OLED. The materials for the layers forming the package are chosen so that the package does not obstruct the intended function of the device. For an OLED package, at least one package layer needs to be transparent. Metal, such as aluminum, is a good material in terms of moisture and oxygen impermeability for the non-transparent layer. Glass is an excellent choice for the transparent side. One method is to fabricate the device on a glass substrate and then to sandwich it between another glass or metal layer. In this design, because glass has excellent barrier properties for water and oxygen, the weak point in the design is usually the material used to join the device substrate to the other glass or metal layer.

However, the need for a flexible more rugged device and cost effectiveness drives the need for plastic for both or just the transparent layer of the package. Plastics unfortunately lack hermeticity. Attempts have been made to coat plastics with various inorganic layers to provide a barrier to water and/or oxygen diffusion. For plastic substrates that hold the possibility of being mechanically flexible, the main efforts have involved depositing an inorganic coating like SiO₂ or Si₃N₄, or a multilayer or multizone inorganic-organic hybrid coating onto the plastic film. However, to date, barrier films of plastics have not equaled the performance of glass. The reason for this is primarily due to imperfections such as pinholes in the barrier coating. These imperfections provide a path for water and/or oxygen entry. Another group of imperfections are cracks that often develop during thermal cycling due to the large mismatch in thermal expansion rates for plastics and inorganic components for barrier coatings. Thus, mechanically flexible organic electroluminescent devices have not been available for practical applications to-date.

Regardless of the material choices made for the front and back sheets of the package, there is an ingress path for moisture and/or oxygen in the seal zones around the OLED between these two sheets. The seal zones are often formed by organic-based adhesives, often based on epoxies that can be permeable. These adhesives become pathways for moisture and oxygen ingress over time. The effect of moisture and oxygen ingress is visually observed as dark spots that form in the light emitting area. In addition to detracting from the light output and aesthetic appearance of the device, the dark spots may also be paths for electrical leakage that decrease the efficiency of the device. Thus it is desirable to reduce the formation and appearance of dark spots in OLED device. In particular, it would be desirable to provide a package for organic light emitting devices that could prevent premature deterioration of the elements of the OLED due to water vapor and oxygen ingress without interfering with the light transmission from the OLED. It would also be desirable to provide such a device, which was flexible.

### BRIEF DESCRIPTION OF THE DRAWINGS

The features and advantages of the present invention can be understood more completely by reading the following detailed description of preferred embodiments in conjunction with the accompanying drawings, in which like reference indicators are used to designate like elements, and in which:

FIG. 1 is a side perspective and exploded view of a hermetically packaged OLED device.

FIG. 2 is a side perspective view of an OLED device with powdered getter material dispersed in a layer in the light path of the OLED device showing scatter of light from the device.

FIG. 3 is a graph of the light intensity distribution of light rays exiting an OLED device as a function of view angle with and without the presence of getter material.

FIG. 4 is a side perspective view of an OLED device with getter material deposited on a surface that lies in the light path emitted by the OLED device in a predefined geometric pattern.

FIGS. 5A-5C show top perspective views of getter particles that may be used in organic light emitting devices according to the present invention. FIGS. 5D and 5E show OLED devices with small intrinsic defects, and the masking effect of a getter layer in FIG. 5E.

FIG. 6 is a side perspective view of a packaged OLED with getter material embedded in an adhesive layer that lies in the light path.

FIG. 7 is a side perspective view of a packaged OLED with getter material deposited on a surface that lies in the light path in a geometric pattern.

### SUMMARY

Briefly, in one aspect, the present invention relates to an organic light emitting device that includes a transparent substrate, a first transparent electrode disposed on the transparent substrate, a second electrode, an electroluminescent layer sandwiched between the electrodes, the transparent substrate disposed on a surface of the first transparent electrode opposite to the electroluminescent layer and a getter layer disposed on a light emitting surface of the substrate opposite the first transparent electrode, and comprising a metal selected from beryllium, magnesium, calcium, strontium, barium, radium and titanium.

### DETAILED DESCRIPTION

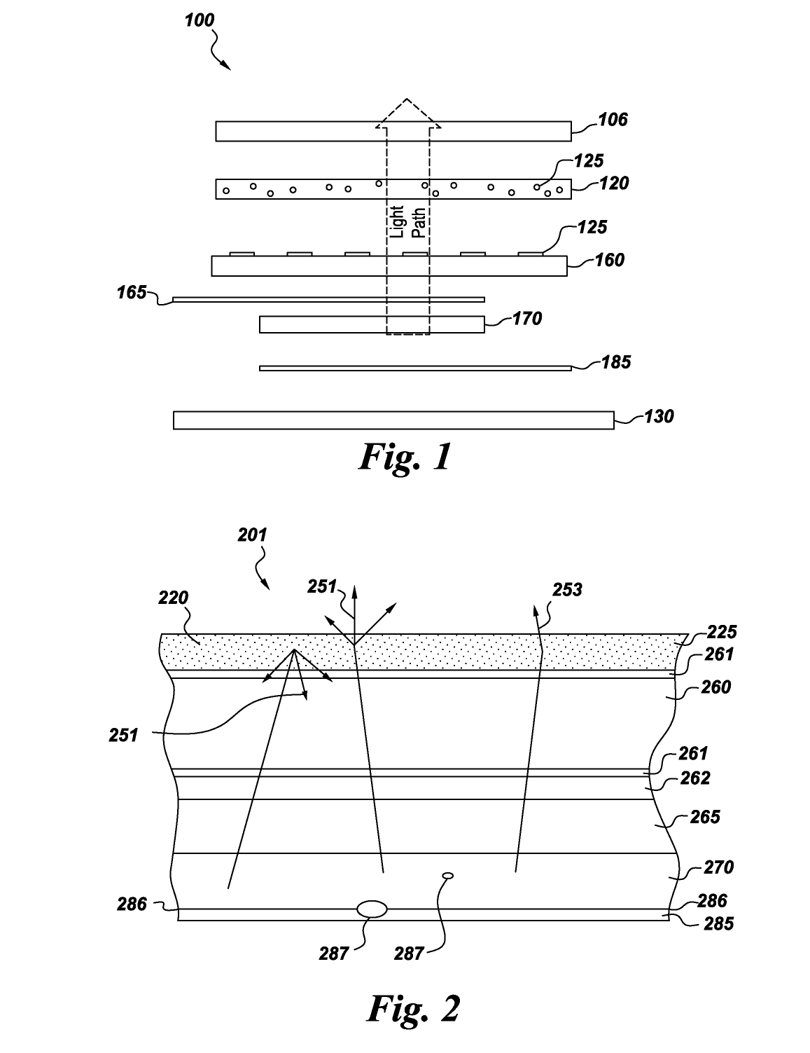

Shown in FIG. 1 is an organic light emitting device according to the present invention. Hermetic package design 100 includes a device that is fabricated on a transparent plastic or glass substrate 160. In the case where the substrate 160 is plastic, hard coating layers and barrier coating layers may be provided on the surfaces of substrate 160. A transparent conductive oxide layer or other conductive layer is provided on the surface of substrate 160 to form the first set of electrodes (anodes) 165. Electroluminescent or light emitting layer 170 is disposed on anode 165. Typically, the organic light emitting layer 170 comprises electroluminescent organic solids which emit light when subjected to a current. Numerous such materials are known in the art, and the present invention is not limited to a particular one. On top of the electroluminescent layer 170 is the second electrode (cathode) 185. Layer 120 is an optional transparent adhesive layer for optical coupling.

The OLED device is encapsulated in a hermetic package consisting of a transparent front sheet 106 and back sheet 130. The front sheet 106 can have optional hard coating layers and a barrier coating and is intended to be impermeable to moisture and oxygen ingress. The back sheet 130 can be a multilayer structure consisting of a hermetic metal layer and an insulating adhesive layer. The back sheet has sufficient thickness and homogeneity so that it is impermeable to oxygen and moisture.

Getter 125 is placed in the path of the light emitted by the OLED device. In one aspect, getter 125 consists of particles dispersed in adhesive layer 120 to block the ingress of moisture and oxygen through defects in transparent front sheet 106. Effective transparency of adhesive layer 120 is maintained by selecting getter particles that reflect and scatter emitted light. In a second aspect, getter 125 consists of dots of arbitrary shape and size disposed on the surface of substrate layer 160 or transparent layer 106 and facing adhesive layer 120. Effective transparency is maintained as emitted light internally reflects from the surface of the getter dots to the OLED and back until the light passes the getter.

The getter acts to absorb water and/or oxygen that make it through imperfections in the front sheet 106, optional hard coat layers and barrier coating. The resulting packaged OLED device will exhibit a longer life than an OLED device with a barrier coating alone. In particular, getter 125 may be located on either side of adhesive layer 120, or alternately, within layer 120. The size and distribution of getter particles is selected to enhance the appearance and light output of the OLED, whereas a continuous layer of getter material would diminish light output.

As used herein the term getter is generally defined as a chemical agent that reacts with water (moisture) and/or oxygen. Although specific reference will be made to its use with optoelectronic devices such as OLED devices, it should be apparent that the getter could be utilized in a wide range of packaging applications where moisture and/or oxygen removal is desirable. The getter is not intended to be limited to OLED devices and as such can be used in any packaging application of highly moisture and oxygen sensitive applications. These applications include, but are not limited to, applications such as micro-electro-mechanical sensors (MEMS) devices, flat panel displays, field emission displays, plasma displays, charge coupled devices, photovoltaic devices and the like. Materials for use as a getter for water and/or oxygen are metals selected from beryllium, magnesium, calcium, strontium, barium, radium and titanium. The metal may be in elemental form or in the form of an alkali earth oxide, an alkali earth metal sulfate, an alkali earth metal halide, an alkali earth metal perchlorate, or a mixture thereof. Suitable metals in elemental form include titanium and the alkali earth metals beryllium, magnesium, calcium, strontium, barium, radium, and mixtures thereof, particularly titanium, magnesium, calcium, and barium, and more particularly calcium. Suitable metals in the form of an oxide include alkali earth metal oxides, particularly barium oxide BaO, strontium oxide SrO, calcium oxide CaO and magnesium oxide MgO, and mixtures thereof, and more particularly calcium oxide.

In one embodiment depicted in FIG. 2, getter particles 225 are embedded or randomly dispersed on or in adhesive layer 220. The light emitting side is indicated as 201. The light rays 251, 252 and 253 generated in the organic light emitting layer 270 travel through transparent anode layer 265, optional transparent barrier coating 262, hard coating layers 261, OLED substrate 260 and finally through top adhesive layer 220 with embedded getter particulates 225. Other layers that are part of a hermetic package 100 encapsulating the OLED device are not shown. In some embodiments, getter particles 225 have an average size that is larger than the characteristic wavelength of light emitted by the OLED device. The characteristic wavelength is defined as the wavelength at which the peak intensity of the OLED output light spectrum occurs. The size of a getter is defined as the diameter of the minimum imaginary circumscribing sphere around the getter particulate. Particle size of materials suitable for use in a getter layer of an OLED according to the present invention is greater than about 200 nm, and particularly greater than about 1000 nm.

Getter particles with an average size greater than the characteristic wavelength of the light emitted by the OLED device can cause light scatter due to diffuse reflection at the particle. The light rays from the OLED device can be scattered in the forward direction 251 or backward direction 252 or not at all 253 if the light ray does not hit a getter particle. Light rays that are scattered in the backward direction 252 are reflected on the optically reflective surface 286 of the cathode and are not lost due to absorption. Unlit dark spots 287 can arise due to defects in the anode 265, the cathode 285 or the light emitting layer 270. On the one hand, the getter particles trap moisture and oxygen that can create these defects, and on the other hand they scatter light emitted from light emitting layer 270 and disguise the defects.

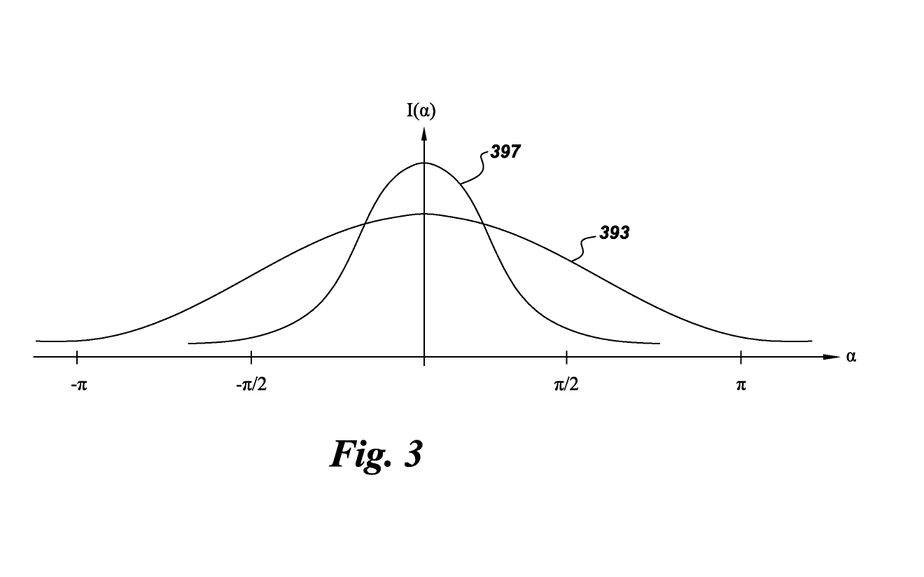

As shown in FIG. 3, the view angle α is defined as the angle between the light ray coming through the getter layer and a surface normal. The intensity curve 393 of scattered light plotted over a view angle from −π to +π has a lower peak value but a broader upper and lower tail than an intensity curve 397 of unscattered light. The intensity curves can change depending on the plane of view angle α. Scatter is acceptable or even increases total light extraction if there is very little absorption in the system.

Getter in powder form can be deposited on the web in a roll-to-roll like process using a number of different methods. For example, the getter may be embedded into the thermoplastic adhesive layer using roll or pouch lamination, heat seal pressing or vacuum lamination.

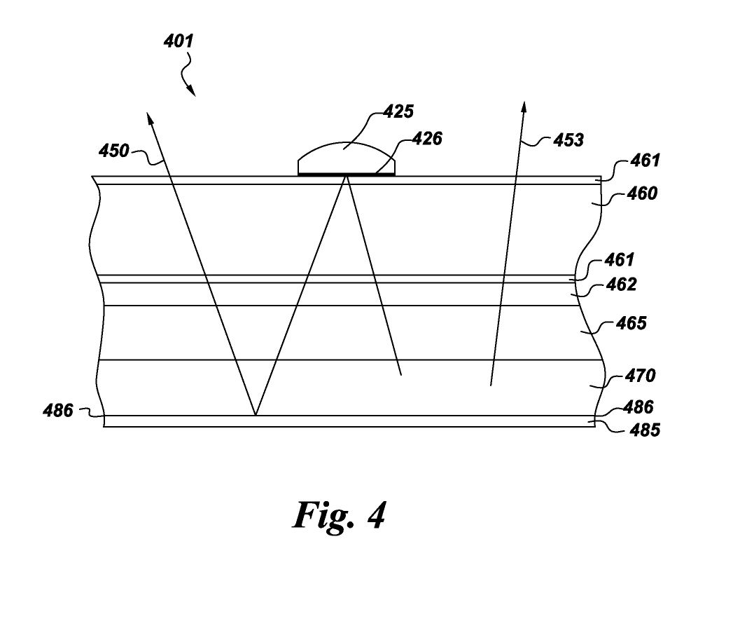

In another embodiment, illustrated in FIG. 4, getter 425 is deposited on the transparent substrate 460 to form a structured pattern of dots. This surface is on the light emitting side 401 of the device or package and over the light emitting area of the device. Getter 425 may be placed on the optional hard coating 461 on the transparent substrate 460. Other surfaces that are within the package and in the path of the emitted light are also possible.

Effective transparency of the getter layer is achieved because getter dots 425 are very small and have a highly reflective surface 426 on the surface facing the light emitting side of the device. Light absorption by getter dots 425 is minimal, and many light rays 450 coming from the electroluminescent layer 470 are reflected back and forth between the reflecting side of the getter 426 and the reflecting side 486 of electrode (cathode) 485 through electrode (anode) 465, barrier coating 462, hard coat 461, substrate 460 and second hard coat 461. Much of the light is internally reflected until it escapes the device. Other light rays 453 are not reflected or otherwise affected by the getter at all. Because of effective transparency of the getter layer, the getter can be placed anywhere in the device, including, but not limited to, over active light emitting zones of the device, on cathode and anode surfaces, directly over transparent OLED devices, and the like.

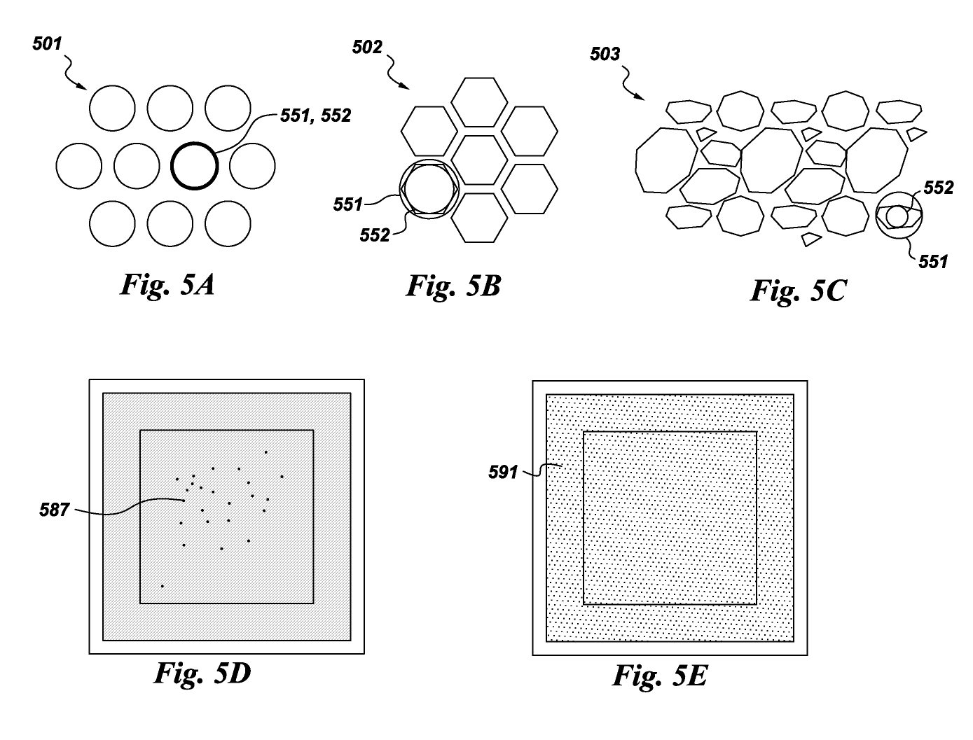

The shape of the getter dots may be round 501, hexagonal 502 or any other shape 503 in an ordered or random arrangement as illustrated in FIGS. 5A-5C. The size of the getter dots is defined as the diameter of the smallest circumscribed imaginary circle around the dot 551. For random dots an average diameter and a distribution of diameter values is calculated. The form factor of a getter dot is characterized by the ratio of the diameter of the imaginary maximum inscribed circle 552 and the diameter of the imaginary minimum circumscribed circle 551. For random dots an average and distribution of ratios is calculated. The density of the getter pattern is characterized using a fill factor. The fill factor of the pattern is defined as the ratio between the area covered by getter material and the total area. For randomly spaced and shaped dots the fill factor is calculated over a sufficiently large sample area that is representative of the entire area of the getter pattern. For devices according to the present invention, fill factor is less than about 50%, particularly less than about 5%.

A comparison of FIGS. 5D and 5E illustrates the hiding power of a getter layer in a device according to the present invention. FIG. 5D is a top view of the light-emitting surface of a device that does not contain a getter layer, and clearly reveals intrinsic defects 587 in the device. FIG. 5E is a view of a device according to the present invention, containing getter particles 591, which mask the defects, making them less noticeable. The design of the getter pattern can accommodate different requirements for transparency, optical defect hiding power and other aspects of optical design. For example, the distribution of dot size and shape and the fill factor may be varied across the light emitting area of the OLED device to achieve higher defect hiding power, less transparency and better gettering properties, for example, near the edges of the light emitting area of the OLED device where defects due to edge ingress might be more likely to occur.

The getter dot pattern can be deposited using evaporation, screen printing, spraying or other techniques that are favorable for a roll-to-roll type manufacturing process. Other methods include the selective removal of getter from a homogenously covered web.

### EXAMPLE 1

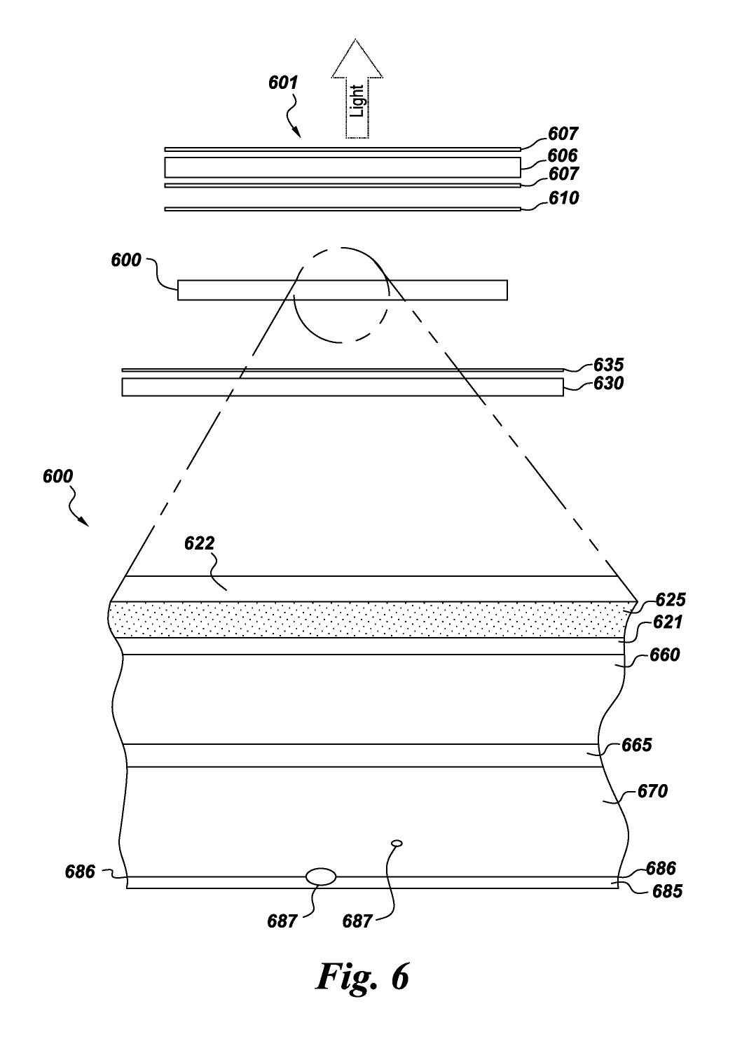

In an embodiment depicted in FIG. 6, device 600 was built on substrate 660. Device 600 included first electrode (anode) 665, light emitting layer 670, and top electrode (cathode) 685 which had a highly reflective surface 686 facing towards the substrate 660.

The OLED device was encapsulated in a hermetic package comprised of a back sheet 630 and a transparent front sheet 606. The front sheet 606 that was placed on the light emitting side 601 of device 600 had a hard coating 607 on both sides and moisture barrier layer 610. The two sheets 606 and 630 were bonded to each other along a circumferential region with a suitable sealant 635 and with the OLED device 600 residing in the center.

Back sheet 630 was cut out from a multilayer material, which comprised a thin interface layer of adhesive 635 and an aluminum barrier layer. The back sheet 630 was degassed for 12 hours at 100° C. A dried CaO getter 625 in powder form was dispersed on a first sheet of transparent adhesive 621 made from Primacor 3460, a co-polymer of ethylene and acrylic acid manufactured by Dow Chemical. The Primacor sheet was baked for 6 hours at 100° C. to reduce its moisture content, and a layer of the CaO particles about 10 um thick layer and corresponding to approximately 3 particles thick was laid down on the sheet. The particles were evenly distributed by means of a bristle brush and excess material was removed. The CaO powder adheres well to the Primacor 3460 even at room temperature because of the opposing electrostatic charge of the film and the powder. To further embed the CaO powder 625 into the adhesive layer 621, the sheet was fed through a pouch laminator at 160° C. and a speed of 400 mm/min. A second sheet of Primacor 3460 adhesive 622 was laminated to the CaO side of sheet 621 using the same laminator settings. The lamination process could be done at a temperature between 90° C. and 130° C., but most preferably 120° C., and a pressure of 7 kPa to 207 kPa, and most preferably 100 kPa, for a time between 1 second and 10 minutes, and most preferably 30 seconds.

The stack composed of getter layer 625 and adhesive layers 621 and 622 was transferred into an inert glove box and attached to the light emitting side of the OLED 600. The back sheet 630 was attached to the OLED device 600 by means of adhesive 635 using roll lamination.

An optical transmission measurement of the CaO particles 625 dispersed in adhesive layers 621 and 622 was performed for wavelengths between 300 nm and 800 nm. The analysis showed that the getter layer had a transmission between 5% and 15% measured on a 7-degree cone angle, but the total transmission over an entire hemisphere (180 degree cone angle) was between 60% and 70%. A reflectance measurement of the CaO particles 625 dispersed in adhesive layers 621 and 622 was also performed in a wavelength range between 300 nm and 800 nm. This measurement showed that the diffuse reflection was between 25% and 27% while the total reflection was between 30% and 32%. Therefore, only a small amount of light that was reflected back towards the light emitting side of the OLED was scattered. Light that was lost due to absorption or total internal reflection in the layers was negligible.

When the OLED device 600 was energized the CaO getter particles 625 on the light emitting side 601 created considerable light scatter. The light scatter obscures smaller intrinsic defects 687 of the OLED. A 500-hour shelf life test was performed with the so created part in an environment of 90% relative humidity and a temperature of 60° C. A benchmark part was used as a control that had no getter material but otherwise the same construction. The getter slowed down the growth of dark spots in the test device when compared to the control and also had a greater hiding power for smaller defects.

### EXAMPLE 2

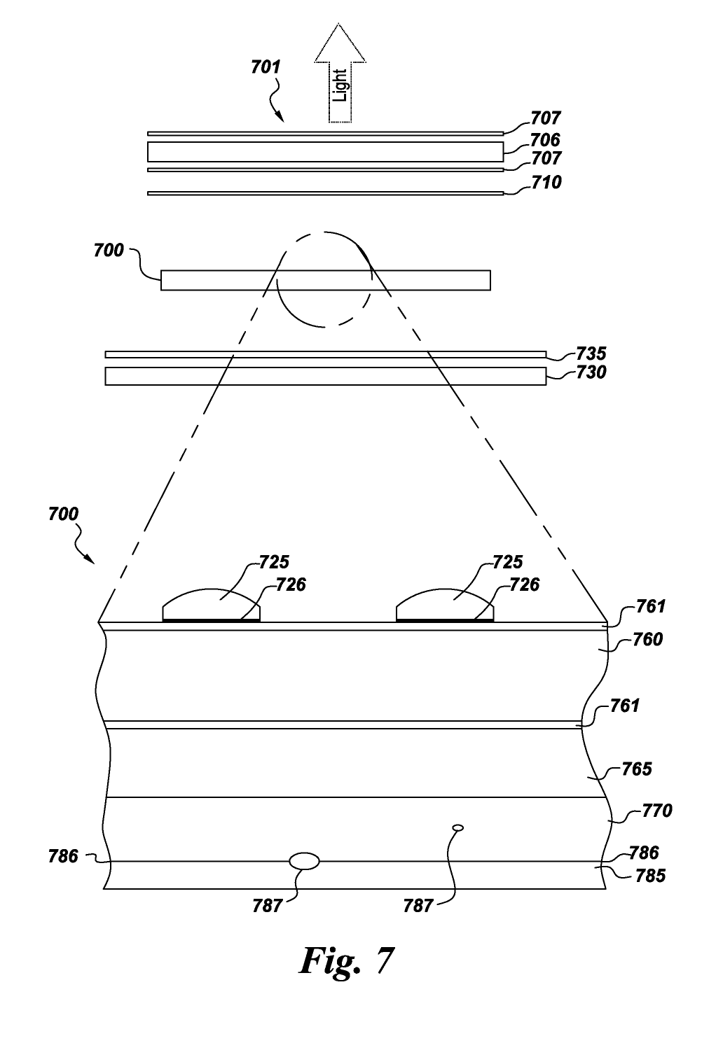

In an embodiment depicted in FIG. 7, device 700 was built on substrate 660. with hard coating layers 761 on both sides. Device 600 included first electrode (anode) 765, light emitting layer 770, and top electrode (cathode) 785 which had a highly reflective surface 786 facing towards the substrate 660.

The OLED device was encapsulated in a hermetic package comprised of a back sheet 730 and a transparent front sheet 706. The front sheet 706 on the light emitting side 701 of device 700 had a hard coating 707 on both sides and moisture barrier layer 710. The two sheets 706 and 730 were bonded to each other along a circumferential region with a suitable sealant 735.

The getter was deposited in a periodic pattern of circular dots 725 on hard coating layer 761 of transparent substrate 760. The getter was, therefore, in the light path on the light emitting side 701 of the device 700. The side of the getter material facing the light coming from device 700 was an optically reflective surface 726. The shape of the dots was circular, and the form factor was therefore equal to 1. The diameter of the dots was constant over the light emitting area and equal to 100 nm. The fill factor, also constant over the light emitting area, was π/8 or approximately 39%. Dots 725, composed of elemental calcium, were deposited by thermal evaporation under vacuum using a 2 mil-thick Polyimide mask with an array of laser-cut holes. The Polyimide mask and the transparent substrate 760 with hard coat layers 761 were fully degassed prior to deposition of getter.

When the device 700 was energized the particles dots 725 obscures intrinsic defects 787 of the OLED. A 500-hour shelf life test was performed with the so created part in an environment of 90% relative humidity and a temperature of 60° C. A benchmark part was used for comparison that had no Ca getter material but otherwise the same construction. By reacting with incoming or intrinsic moisture the Ca getter slowed down the growth of dark spots when compared to the control. The getter pattern obscured defects.

In many embodiments, it is desirable to employ the maximum amount of getter (to maximize the ability of the substrate to scavenge for water and/or oxygen) without causing a substantial diminution in desired physical properties of the substrate material. This means that the thickness of the deposited getter material and the fill factor of the pattern should be maximized. By way of example, in some OLED devices, maximum transparency is desirable. In these types of embodiments, the transparency of the getter layer is typically chosen such that less than 50% of the light emitted by the OLED is absorbed by the getter and preferably less than 10%. Other types of applications may require different transparency requirements.

When lit up, the device looked more uniform than one without dots, because the dots obscured defects in the device. The device also was no dimmer than a control part that contained no getter layer but was otherwise of the same construction. A 500-hour shelf life test was conducted with both parts in an environment of 90% relative humidity and a temperature of 60° C. After 500 hours in this environment, the part with Ca dots had fewer defects than the control. The getter prevented moisture ingress from reaching the OLED device by chemically reacting with the water or oxygen and being consumed in the process.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An organic light emitting device comprising a transparent substrate, a first transparent electrode disposed on the transparent substrate, a second electrode, an electroluminescent layer sandwiched between the electrodes, the transparent substrate disposed on a surface of the first transparent electrode opposite to the electroluminescent layer; and a getter layer disposed on a light emitting surface of the substrate opposite the first transparent electrode, and comprising a metal selected from beryllium, magnesium, calcium, strontium, barium, radium and titanium.

2. An organic light emitting device according to claim 1, wherein the metal is an alkali earth metal.

3. An organic light emitting device according to claim 1, wherein the metal is magnesium, calcium, or barium.

4. An organic light emitting device according to claim 1, wherein the metal is calcium.

5. An organic light emitting device according to claim 1, wherein the getter layer additionally comprises an adhesive.

6. An organic light emitting device according to claim 1, wherein the getter is disposed on a surface of the adhesive material.

7. An organic light emitting device according to claim 1, additionally comprising a barrier coating disposed on the light emitting surface of the organic light emitting device, wherein the getter layer is disposed between the transparent electrode and the barrier coating.

8. An organic light emitting device according to claim 1, wherein the getter layer comprises a metal in elemental form, selected from calcium, barium, magnesium and titanium.

9. An organic light emitting device according to claim 1, wherein the metal is calcium.

10. An organic light emitting device according to claim 1, wherein the alkali earth metal is distributed on the surface in a pattern of dots.

11. An organic light emitting device according to claim 10, wherein the dots are circular or hexagonal in shape.

12. An organic light emitting device according to claim 10, wherein the pattern has a fill factor of less than about 50%.

13. An organic light emitting device according to claim 10, wherein the pattern has a fill factor of about 5%.

14. An organic light emitting device according to claim 10, wherein the dots have a form factor between 1 and 500.

15. An organic light emitting device according to claim 10, wherein characteristic size of the dots ranges from about 2 nm to about 100 μm.

16. An organic light emitting device according to claim 1, wherein the metal is in particulate form, having particle size greater than about 200 nm.

17. An organic light emitting device according to claim 1, wherein the metal is in particulate form, having particle size greater than about 1000 nm.

18. An organic light emitting device according to claim 1, wherein the getter layer comprises an alkali earth oxide, an alkali earth metal sulfate, an alkali earth metal halide, an alkali earth metal perchlorate, or a mixture thereof.

19. An organic light emitting device according to claim 1, wherein the getter layer comprises calcium oxide, barium oxide, strontium oxide, magnesium oxide, or a mixture thereof.

20. An organic light emitting device according to claim 1, wherein the getter layer comprises calcium oxide.
